(19) United States
(12) Patent Application Publication
(10) Pub. No.: US 2014/0149684 A1
(43) Pub. Date: May 29, 2014

(54) APPARATUS AND METHOD OF CONTROLLING CACHE

(71) Applicant: SAMSUNG ELECTRONICS CO., LTD, Suwon-si (KR)

(72) Inventors: Wonchang LEE, Seongnam-si (KR); Do-Hyung Kim, Hwaseong-si (KR); S.H. Lee, Seoul (KR)

(73) Assignee: SAMSUNG ELECTRONICS CO., LTD., Suwon-si (KR)

(21) Appl. No.: 13/955,687

(22) Filed: Jul. 31, 2013

(30) Foreign Application Priority Data
Nov. 29, 2012 (KR) 10-2012-0137062
Mar. 4, 2013 (KR) 10-2013-0022713

(51) Int. Cl. G06F 12/08

(52) U.S. Cl. CPC G06F 12/0815
USPC 711/141

(57) ABSTRACT

An apparatus and method for controlling a cache may include a cache controller configured to collect a portion of data corresponding to a cache miss in the data at one time, and a data operation unit configured to perform an operation on the data based on the collected data.

### CROSS-REFERENCE TO RELATED APPLICATIONS

This application claims the priority benefit of Korean Patent Application No. 10-2012-0137062, filed on Nov. 29, 2012, and Korean Patent Application No. 10-2013-0022713, filed on Mar. 4, 2013, in the Korean Intellectual Property Office, the disclosures of which are incorporated herein by reference.

### BACKGROUND

1. Field

One or more embodiments relate to decreasing data transmission overhead using a method and apparatus for controlling a cache.

2. Description of the Related Art

With the development in image related technology, technology for encoding and decoding high quality of full high definition (FHD)/ultra high definition (UHD) images is required and accordingly, further detailed image processing technology is required.

For example, the case of a motion compensation method for encoding, data stored in an external memory may be repeatedly required. In this example, the same data may be unnecessarily duplicated and be transmitted. Accordingly, overhead may significantly increase due to access to the external memory.

In the case of using an internal cache memory, when duplicate data is present within a cache, the data may be directly read from the cache without accessing the external memory.

When a central processing unit (CPU) uses an address of predetermined main memory storage, the internal cache memory may verify whether the address is present within a cache. When the address is present within the cache, the internal cache memory may immediately transfer corresponding data to the CPU. Accordingly, the CPU may have no need to access the main memory storage. However, when the address is absent within the cache, the internal cache memory may read corresponding data from the main memory storage and may store the read data in the cache and then, transfer the stored data to the CPU.

In general, a cache memory may be divided in a one-dimensional (1D) line cache, a two-dimensional (2D) block cache, and the like.

### SUMMARY

The foregoing and/or other aspects may be achieved by one or more embodiments of an apparatus for controlling a cache, which may include: a cache controller to collect data of a portion corresponding to a cache miss in the data; and a data operation unit to perform an operation on the data based on the collected data.

The cache controller may include: a cache hit/miss determining unit to determine a cache hit or the cache miss with respect to the data; and a cache miss data requesting unit to request an external memory for data of the portion corresponding to the cache miss in the data, based on the determined cache hit or cache, miss and to thereby collect data.

The data may include video data.

The data operation unit may perform a motion compensation operation on the data based on the collected data.

The foregoing and/or other aspects may be achieved by one or more embodiments of an apparatus for controlling a cache, which may include: a cache hit/cache miss determining unit configured to verify data sets of cache miss in the data; a cache miss data requesting unit configured to request an external memory for the verified data sets in order required for an operation, and to consecutively receive the requested data sets after overhead of a predetermined time; and a data operation unit configured to perform an operation on the data using the data sets that are consecutively received from the external memory after the overhead of the predetermined time.

The data sets may include a first data set and a second data set. The first data set may be a set of data that may be required for the operation and may be in a cache miss state in data included in a first buffer. The second data set may be a set of data that may be required for the operation and may be in the cache miss state in data included in a second buffer.

The cache miss data requesting unit may request the first data set and the second data set from the external memory, and may receive the second data set in succession to the first data set after the overhead of the predetermined time.

At least one of the first buffer and the second buffer may include at least one of a line cache and a block cache.

The cache miss data requesting unit may start to receive the second data set while performing an operation on the first data set.

The foregoing and/or other aspects may be achieved by one or more embodiments of a method of controlling a cache, which may include: collecting, by a cache controller, data of a portion corresponding to a cache miss in the data; and performing, by a data operation unit, an operation on the data based on the collected data.

The collecting may include: determining, by a cache hit/miss determining unit, a cache hit or the cache miss with respect to the data; and requesting, by a cache miss data requesting unit, an external memory for data of the portion corresponding to the cache miss in the data, based on the determined cache hit or cache miss, to collect data.

The data may include video data, and the performing may include performing a motion compensation operation on the data based on the collected data of the portion corresponding to the cache miss.

The foregoing and/or other aspects may be achieved by one or more embodiments of a method of controlling a cache, which may include: verifying, by a cache hit/cache miss determining unit, data sets of cache miss in the data; requesting, by a cache miss data requesting unit, an external memory for the verified data sets required for an operation, to consecutively receive the requested data sets after overhead of a predetermined time; and performing, by a data operation unit, an operation on the data using the data sets that are consecutively received from the external memory after the overhead of the predetermined time. The data sets may include a first data set and a second data set. The first data set may be a set of data that is required for the operation and is in a cache miss state in data included in a first buffer. The second data set may be a set of data that is required for the operation and is in the cache miss state in data included in a second buffer.

The receiving may include receiving the second data set in succession to the first data set after the overhead of the predetermined time.

The receiving may include starting to receive the second data set while performing an operation on the first data set.

Additional aspects and/or advantages of one or more embodiments will be set forth in part in the description which follows and, in part, will be apparent from the description, or may be learned by practice of one or more embodiments of disclosure. One or more embodiments are inclusive of such additional aspects.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a configuration of a cache controlling apparatus according to one or more embodiments;

FIG. 2 illustrates a configuration of a cache controlling apparatus according to one or more embodiments;

FIG. 3 illustrates a diagram to describe a cache miss and a cache hit of a line cache according to one or more embodiments;

FIG. 4 illustrates a diagram to describe a cache miss and a cache hit of a block cache according to one or more embodiments;

FIGS. 5A and 5B illustrate diagrams to describe timing for accessing a cache according to one or more embodiments, such as the embodiment illustrated in FIG. 3; and

FIG. 6 illustrates an operation method of a cache controlling apparatus according to one or more embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein, as various changes, modifications, and equivalents of the systems, apparatuses and/or methods described herein will be understood to be included in the invention by those of ordinary skill in the art after embodiments discussed herein are understood. Accordingly, embodiments are merely described below, by referring to the figures, to explain aspects of the present invention.

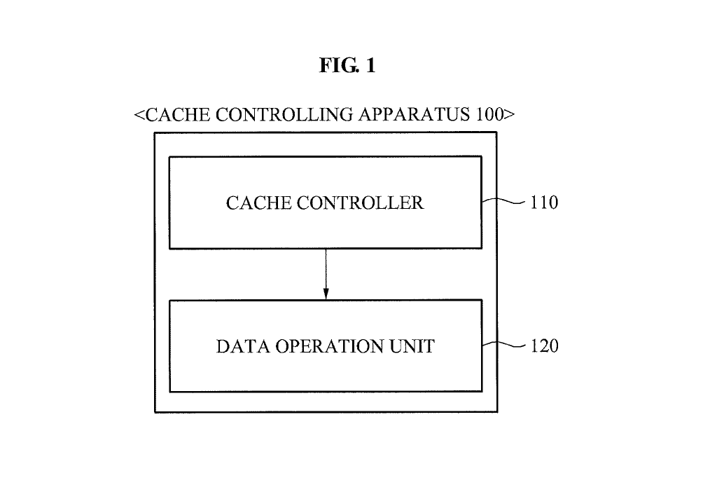

FIG. 1 illustrates a configuration of a cache controlling apparatus 100 according to one or more embodiments.

The cache controlling apparatus 100 according to one or more embodiments may verify in advance a cache miss or a cache hit with respect to required data and may fill in another line cache or block cache while performing an operation on actual data, in order to reduce cache overhead.

In the case of video data, a position and size of data desired to be transmitted may be known in advance and thus, the cache miss or the cache hit with respect to the data may be verified in advance prior to performing a data operation.

The cache controlling apparatus 100 may decrease external data transmission overhead by requesting a required line cache or block cache from an external memory at one time.

The cache controlling apparatus 100 may relatively further decrease a transmission time according to an increase in latency of the external memory.

Referring to FIG. 1, the cache controlling apparatus 100 may include a cache controller 110 and a data operation unit 120.

The cache controller 110 may collect data of a portion corresponding to a cache miss in the data. The cache controller 110 may verify in advance the cache miss or a cache hit with respect to the required data and may fill in another line cache or block cache while performing an operation on actual data.

For example, the data may include video data of which a cache miss or a cache hit may be verified in advance prior to performing a data operation.

The data operation unit 120 may perform an operation on the data based on the collected data of the portion corresponding to the cache miss.

When the data includes video data, the data operation unit 120 may perform a motion compensation operation on the data based on the collected data.

Motion compensation may include a compression method that estimates a subsequent screen by comparing a previous screen and a current screen in, for example, a digital video disk (DVD), etc. For example, motion picture experts group (MPEG)-2 compression technology divides an image into a large number of items of data, and newly draws only a portion of each data in which a motion varies.

Motion compensation may be used for compression technologies, such as MPEG4, H.264, and high efficiency video coding (HEVC), for example, as well as MPEG-2 compression technology.

The data may be used for such motion compensation. Thus, with respect to divided data, the cache controller 110 may verify in advance a portion corresponding to the cache miss and a portion corresponding to the cache hit.

According to one or more embodiments, the cache controlling apparatus 100 may decrease data transmission overhead that may occur when filling in a cache through access to an external memory in the case of a cache miss.

In the case of video image processing using a cache, the cache controlling apparatus 100 may decrease an image processing time and may also perform encoding by reducing overhead that occurs due to latency of the external memory.

The cache may include a line cache or a block cache.

When the cache includes the line cache, the cache may include first line data, second line data, and so on through n^{th} line data.

For example, when the first line data and the third line data correspond to the cache miss, the cache controlling apparatus 100 may verify that the first line data and the third line data correspond to the cache miss and may request the external memory for the first line data and the third line data from the external memory at one time.

The first line data and the third line data may be consecutively input into the cache after a predetermined period of time has elapsed. The cache controlling apparatus 100 may extract valid data required for an operation, and may perform a data operation.

The cache controlling apparatus 100 may verify data sets of cache miss from the data.

The data sets of cache miss may be interpreted as valid data required for the operation, in data present within a line cache or a block cache. Also, each of the data sets may be classified for each line cache or block cache.

For example, in data present within a first line cache, data that is used for an operation and thus, is classified into valid data and is in a cache miss state may be defined as a first data set. In data present within a second line cache, data that is used for an operation and thus, is classified into valid data and is in the cache miss state may be defined as a second data set.

The cache controlling apparatus 100 may request the verified data sets of cache miss from the external memory in the order required for the operation. The cache controlling apparatus 100 may consecutively receive the requested data sets after an overhead of a predetermined time.

The cache controlling apparatus 100 may request the external memory for the first data set and the second data set, and may receive the second data set in succession to the first data set after an overhead of a predetermined time. In this example, the cache controlling apparatus 100 may start to receive the second data set while performing an operation on the first data set.

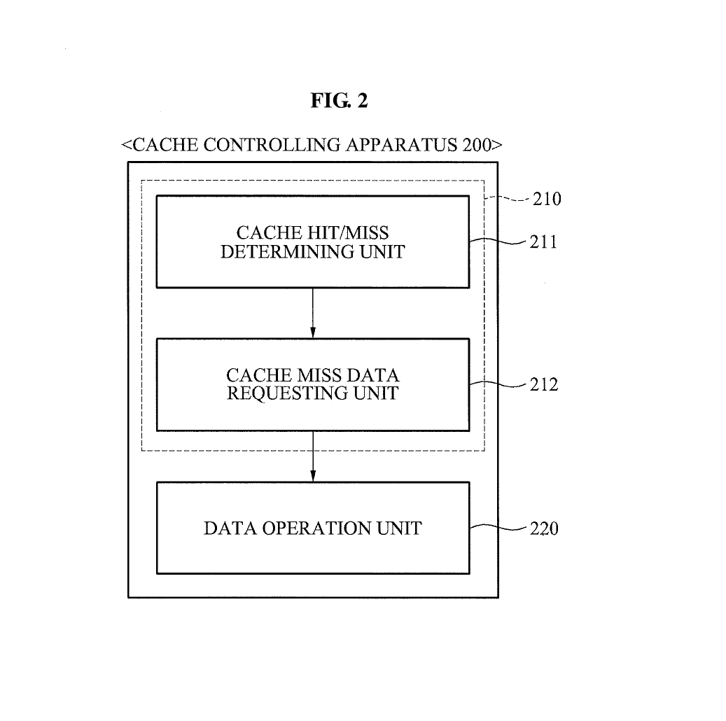

FIG. 2 illustrates a configuration of a cache controlling apparatus 200 according to one or more embodiments.

The cache controlling apparatus 200 according to one or more embodiments may verify in advance a cache miss or a cache hit with respect to required data and may fill in another line cache or block cache while performing an operation on actual data, in order to reduce cache overhead.

Referring to FIG. 2, the cache controlling apparatus 200 may include a cache controller 210 and a data operation unit 220.

The cache controller 210 may collect data of a portion corresponding to the cache miss in the data.

The cache controller 210 may verify in advance the cache miss or the cache hit with respect to the required data and may fill in another line cache or block cache while performing an operation on actual data.

For example, the cache controller 210 may include a cache hit/miss determining unit 211 and a cache miss data requesting unit 212.

The cache hit/miss determining unit 211 may determine the cache hit or the cache miss with respect to the data.

The data may include video data.

In the case of video data, a position and size of data desired to be transmitted may be known in advance and thus, the cache miss or the cache hit may be verified in advance prior to performing a data operation.

The cache hit/miss determining unit 211 may verify in advance a cache hit or a cache miss with respect to the data based on a characteristic of the video data, and may determine in advance data of a portion corresponding to the cache miss or data of a portion corresponding to the cache miss, prior to performing the data operation.

The cache miss data requesting unit 212 may request an external memory for data of the portion corresponding to the cache miss in the data, based on the determined cache hit or cache miss, and may thereby collect data.

The cache miss data requesting unit 212 may not use a time resource while fetching data of the portion corresponding to the cache miss from the external data from a point at which the cache miss is verified.

The data operation unit 220 may perform an operation on the data based on the collected data of the portion corresponding to the cache miss.

When the data includes video data, the data operation unit 220 may perform a motion compensation operation on the data based on the collected data.

In the case of video image processing using a cache, the cache controlling apparatus 200 may decrease an image processing time and may also perform encoding by reducing overhead that occurs due to latency of the external memory.

As an example, the cache hit/miss determining unit 211 may verify data sets of cache miss from the data.

The data sets may include a first data set and a second data set. The first data set may be interpreted as a set of data that is required for an operation and is in a cache miss state in data included in a first buffer. The second data set may be interpreted as a set of data that is required for the operation and is in the cache miss state in data included in a second buffer.

The cache miss data requesting unit 212 may request the verified data sets from an external memory in an order required for an operation, and may consecutively receive the requested data sets after an overhead of a predetermined time.

For example, the cache miss data requesting unit 212 may request the external memory for the first data set and the second data set, and may receive the second data set in succession to the first data set after the overhead of the predetermined time.

For example, the cache miss data requesting unit 212 may start to receive the second data set while performing an operation on the first data set.

The data operation unit 220 may perform an operation on the data using the data sets that are consecutively received from the external memory after the overhead of the predetermined time. The data operation unit 220 may perform a motion compensation operation on the data using the consecutively received data sets.

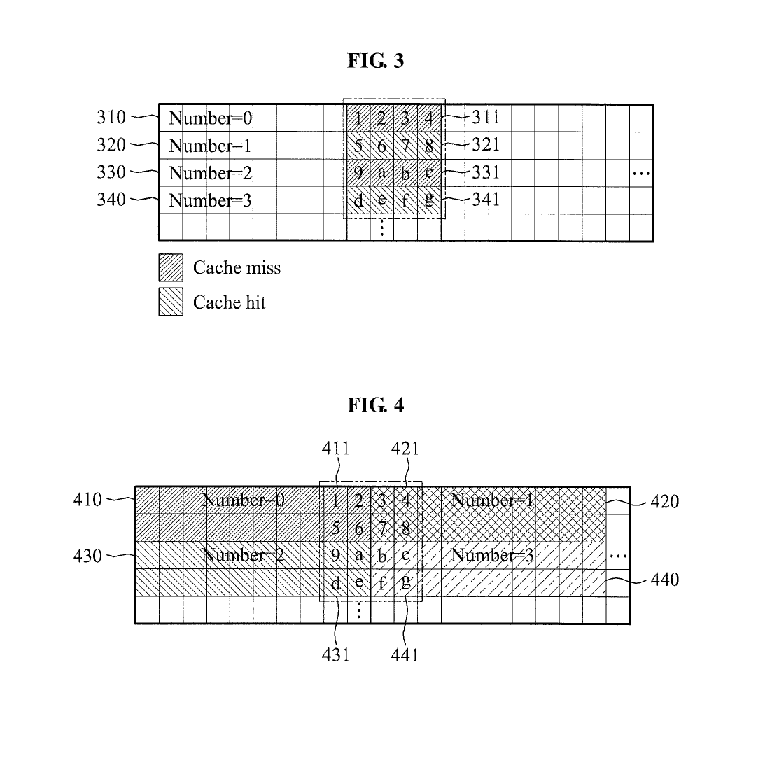

FIG. 3 illustrates a diagram to describe a cache miss and a cache hit of a line cache according to one or more embodiments.

To reduce an increase in overhead due to access to an external memory, when duplicate data is present within a cache, a motion compensation method for encoding may immediately read and use the duplicate data from a cache using an internal cache memory, instead of accessing the external memory.

As illustrated in FIG. 3, when data 311, 321, 331, and 341, including a 4×4 area (1, 2, 3, . . . , g) and required for a motion compensation operation, is present within line caches 310, 320, 330, and 340, respectively, overhead may not increase and a processing rate may be enhanced.

A case in which the data 311 “1, 2, 3, and 4” of the line cache 310 identified by “Number=0” corresponds to the cache miss, the data 321 “5, 6, 7, and 8” of the line cache 320 identified by “Number=1” corresponds to the cache hit, the data 331 “9, a, b, and c” of the line cache 330 identified by “Number=2” corresponds to the cache miss, and the data 341 “d, e, f, and g” of the line cache 340 identified by “Number=3” corresponds to the cache hit will be described.

A cache controlling apparatus according to one or more embodiments may verify in advance whether the data 311 “1, 2, 3, and 4” of the line cache 310 corresponds to the cache miss and the data 331 “9, a, b, and c” of the line cache 330 corresponds to the cache miss, in the data stored in the cache, prior to performing a data operation.

Also, the cache controlling apparatus may verify in advance whether the data 321 “5, 6, 7, and 8” of the line cache 320 corresponds to the cache hit and the data 341 “d, e, f, and g” of the line cache 340 corresponds to the cache hit, in the data stored in the cache, prior to performing the data operation.

The cache controlling apparatus may perform the data operation on the data 321 of the line cache 320 and the data 341 of the line cache 340 without causing latency by access to an external memory.

However, the cache controlling apparatus may need to fetch, from the external memory, the data 311 of the line cache 310 and the data 331 of the line cache 330 corresponding to the cache miss.

Instead of separately fetching the data 311 and the data 331 from the external memory at a point in time when “Number=0” and “Number=2” are processed, the cache controlling apparatus may also fetch the data 331 required for “Number=2”, at a point in time when “Number=0” is processed.

The cache controlling apparatus may be aware of portions corresponding to the cache miss in advance and thus, may fetch data corresponding to the cache miss from the external memory at one time.

Data sets of cache miss may be interpreted as valid data required for a motion compensation operation in data present within a line cache. Each of the data sets may be classified for each line cache.

For example, in data present within the line cache 310 identified by “Number=0”, the data 310 “1, 2, 3, and 4” used for an operation and classified as valid data and in a cache miss state may be defined as a first data set.

In data present within the line cache 330 identified by “Number=2”, the data 330 “9, a, b, and c” used for the operation classified as valid data and in the cache miss state may be defined as a second data set.

The cache controlling apparatus may request the verified data sets from an external memory in an order required for an operation, and may consecutively receive the requested data sets after an overhead of a predetermined time. The cache controlling apparatus may perform an operation on the data using the data sets that are consecutively received from the external memory after the overhead of the predetermined time.

Referring to FIG. 3, the cache controlling apparatus may perform a motion compensation operation using the data 321 and the data 341 that are classified as the cache hit together with the first data set and the second data set that are consecutively received.

Since the first data set and the second data set classified as a cache miss in an initial stage are consecutively received, the cache controlling apparatus may not incur an overhead required to wait for a cache miss data set several times.

For example, while performing an operation on the first data set received after an overhead of the predetermined time, the cache controlling apparatus may start to receive the second data set and thus, may not incur the overhead required to wait for the cache miss data set several times.

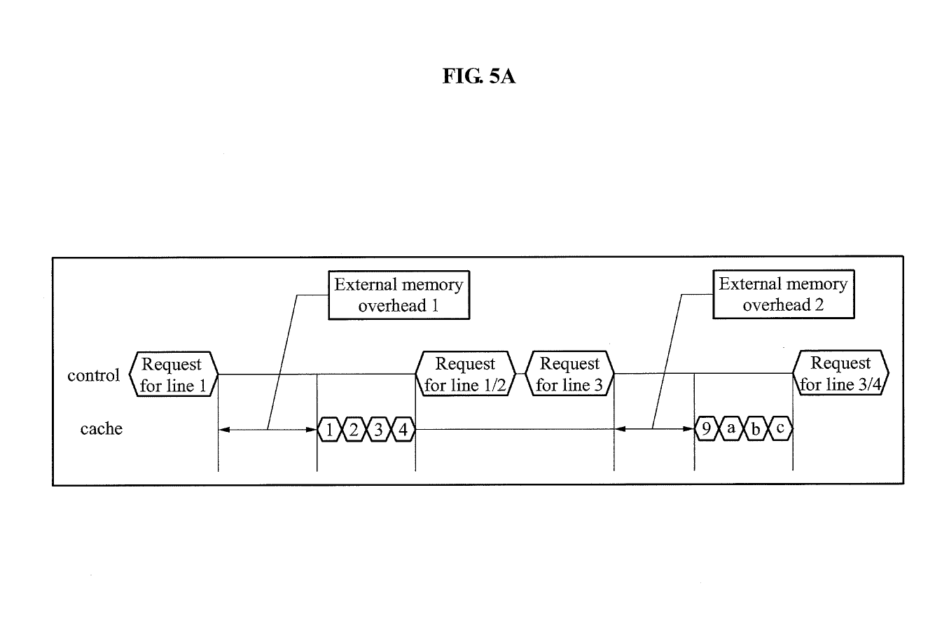

FIG. 4 illustrates a diagram to describe a cache miss and a cache hit of a block cache according to one or more embodiments.

Referring to FIG. 4, when data 411, 421, 431, and 441, including having a 4×4 area (1, 2, 3, . . . , g) and required for a motion compensation operation, is present within block caches 410, 420, 430, and 440, respectively, overhead may not increase and a processing rate may be enhanced.

A case in which the data 411 “1, 2, 5, and 6” of the block cache 410 identified by “Number=0” correspond to the cache miss, the data 421 “3, 4, 7, and 8” of the block cache 420 identified by “Number=1” correspond to the cache hit, the data 431 “9, a, d, and e” of the block cache 430 identified by “Number=2” correspond to the cache miss, and the data 441 “b, c, f, and g” of the block cache 440 identified by “Number=3” correspond to the cache hit will be described.

A cache controlling apparatus according to an embodiment may verify in advance whether the data 411 “1, 2, 5, and 6” of the block cache 410 corresponds to the cache miss and the data 431 “9, a, d, and e” of the block cache 430 corresponds to the cache miss, in the data stored in a cache prior to performing a data operation.

Also, the cache controlling apparatus may verify in advance whether the data 421 “3, 4, 7, and 8” of the block cache 420 corresponds to the cache hit and the data 441 “b, c, f, and g” of the block cache 440 corresponds to the cache hit, in the data stored in a cache prior to performing the data operation.

The cache controlling apparatus may perform the data operation on the data 421 of the block cache 420 and the data 441 of the block cache 440 without causing latency by access to an external memory.

However, the cache controlling apparatus may need to fetch, from the external memory, the data 411 of the block cache 410 and the data 431 of the block cache 430 corresponding to the cache miss.

Instead of separately fetching the data 411 and the data 441 from the external memory at a point in time when “Number=0” and “Number=2” are processed, the cache controlling apparatus may also fetch the data 431 required for “Number=2”, at a point in time when “Number=1” is processed.

The cache controlling apparatus may be aware of portions corresponding to the cache miss in advance and thus, may fetch data corresponding to the cache miss from the external memory at one time.

Data sets of cache miss may be interpreted as valid data required for a motion compensation operation in data present within a block cache. Each of the data sets may be classified for each block cache.

For example, in data present within the block cache 410 identified by “Number=0”, the data 411 “1, 2, 5, and 6” used for an operation and classified as valid data and in a cache miss state may be defined as a first data set.

In data present within the block cache 430 identified by “Number=2”, the data 431 “9, a, d, and e” used for the operation and classified as valid data and in the cache miss state may be defined as a second data set.

The cache controlling apparatus may request the verified data sets from an external memory in an order required for an operation, and may consecutively receive the requested data sets after an overhead of a predetermined time. The cache controlling apparatus may perform an operation on the data using the data sets that are consecutively received from the external memory after the overhead of the predetermined time.

Referring to FIG. 4, the cache controlling apparatus may perform a motion compensation operation using the data 421 and the data 441 that are classified as the cache hit together with the first data set and the second data set that are consecutively received.

Since the first data set and the second data set classified as the cache miss in an initial stage are consecutively received, the cache controlling apparatus may not incur an overhead required to wait for a cache missed data set several times.

For example, while performing an operation on the first data set received after an overhead of the predetermined time, the cache controlling apparatus may start to receive the second data set and thus, may not incur the overhead required to wait for the cache missed data set several times.

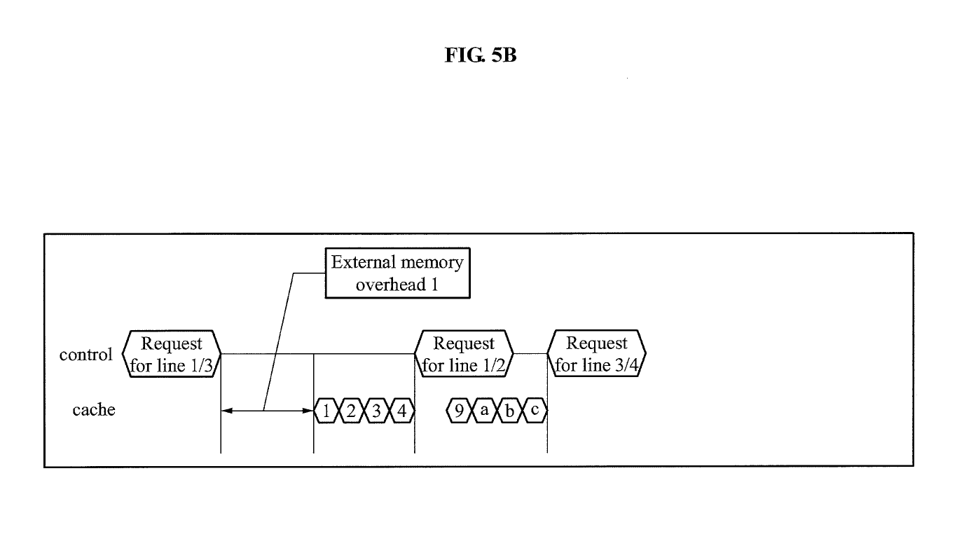

FIGS. 5A and 5B illustrate diagrams to describe timing for accessing a cache according to one or more embodiments, such as the embodiment illustrated in FIG. 3.

Referring to FIG. 5A, cache access timing generally used may be verified.

In general, a first line cache may be filled by fetching, from an external memory, data about line 1 corresponding to a cache miss. In this example, an amount of time corresponding to external memory overhead 1 may be used.

To perform an operation on line 2 corresponding to a cache hit with respect to data “1, 2, 3, and 4” collected from the external memory, and to process line 3 corresponding to the cache miss, it is possible to request the external memory for data “9, a, b, and c” corresponding to the line 3. In this example, an amount of time corresponding to external memory overhead 2 may be used.

Referring to FIG. 5B, cache access timing using a cache controlling apparatus according to one or more embodiments may be verified.

Similar to FIG. 5A, when a cache miss occurs in line 1 and line 3, the cache controlling apparatus may request an external memory for data corresponding to the line 1 and the line 3 and thereby collect the data prior to performing a data operation.

In this example, an amount of time corresponding to external memory overhead 1 may be used.

The cache controlling apparatus may use only the amount of time corresponding to the external memory overhead 1 as a time used to access the external memory and thereafter, may not use a time to access the external memory.

For example, the cache controlling apparatus may collect, from the external memory at one time, data of portions corresponding to the cache miss in the line caches at one time and thus, may decrease an amount of time used to refer to the external memory according to the cache miss.

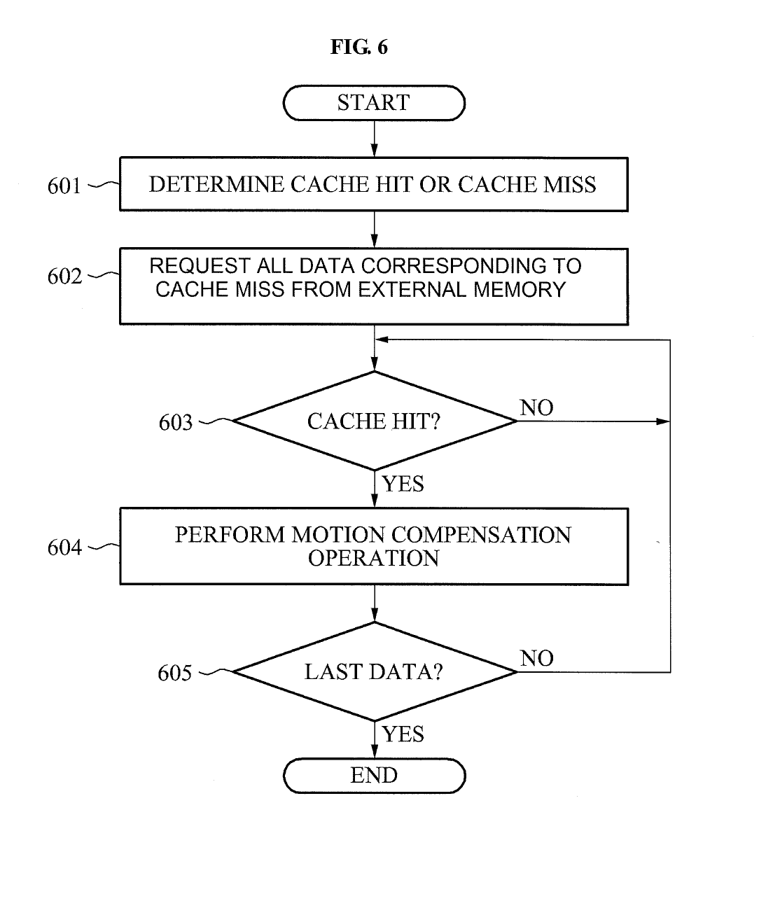

FIG. 6 illustrates an operation method of a cache controlling apparatus according to one or more embodiments.

In the operation method of the cache controlling apparatus, the cache controlling apparatus may collect data of a portion corresponding to a cache miss in the data using a cache controller, and may perform an operation on the data based on the collected data using a data operation unit.

Referring to FIG. 6, in operation 601, the cache controlling apparatus may determine a cache hit or the cache miss with respect to the data using a cache hit/miss determining unit.

In operation 602, the cache controlling apparatus may request data of the portion corresponding to the cache miss in the data from an external memory, based on the determined cache hit or cache miss and may thereby collect data miss using a cache miss requesting unit.

In operation 603, whether there is a cache hit may be determined for the data operation.

In the case that there is no cache hit, operation 603 may be performed again.

Since all of the data of the portion corresponding to the cache miss is requested and collected at one time in operation 602, the determination result of operation 603 may be the cache hit.

To perform an operation on the data, the cache controlling apparatus may perform a motion compensation operation on the data based on the collected data using the data operation unit in operation 604.

In operation 605, the cache controlling apparatus may determine whether data is the last data for the motion compensation operation in the data. When the data is not the last data, the cache controlling apparatus may return to operation 603 to perform an operation of determining whether there is a cache hit.

On the contrary, when the data is the last data in operation 605, the above process may be terminated.

According to one or more embodiments, an operation method of a cache controlling apparatus may verify data sets of cache miss from the data.

Accordingly, the cache controlling apparatus may request the verified data sets from an external memory in an order required for an operation, and may consecutively receive the requested data sets after an overhead of a predetermined time.

The first data set may be interpreted as a set of data that is required for an operation and is in a cache miss state in data included in a first buffer. The second data set may be interpreted as a set of data that is required for an operation and is in the cache miss state in data included in a second buffer.

The cache controlling apparatus may consecutively receive the requested data sets. To this end, the cache controlling apparatus may receive the second data set in succession to the first data set after an overhead of a predetermined time.

For example, the cache controlling apparatus may start to receive the second data set while performing an operation on the first data set.

The cache controlling apparatus may perform an operation on the data using the data sets that are consecutively received from the external memory after the overhead of the predetermined time.

In one or more embodiments, any apparatus, system, element, or interpretable unit descriptions herein include one or more hardware devices or hardware processing elements. For example, in one or more embodiments, any described apparatus, system, element, retriever, pre or post-processing elements, tracker, detector, encoder, decoder, etc., may further include one or more memories and/or processing elements, and any hardware input/output transmission devices, or represent operating portions/aspects of one or more respective processing elements or devices. Further, the term apparatus should be considered synonymous with elements of a physical system, not limited to a single device or enclosure or all described elements embodied in single respective enclosures in all embodiments, but rather, depending on embodiment, is open to being embodied together or separately in differing enclosures and/or locations through differing hardware elements.

In addition to the above described embodiments, embodiments can also be implemented through computer readable code/instructions in/on a non-transitory medium, e.g., a computer readable medium, to control at least one processing device, such as a processor or computer, to implement any above described embodiment. The medium can correspond to any defined, measurable, and tangible structure permitting the storing and/or transmission of the computer readable code.

The media may also include, e.g., in combination with the computer readable code, data files, data structures, and the like. One or more embodiments of computer-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Computer readable code may include both machine code, such as produced by a compiler, and files containing higher level code that may be executed by the computer using an interpreter, for example. The media may also be any defined, measurable, and tangible distributed network, so that the computer readable code is stored and executed in a distributed fashion. Still further, as only an example, the processing element could include a processor or a computer processor, and processing elements may be distributed and/or included in a single device.

The computer-readable media may also be embodied in at least one application specific integrated circuit (ASIC) or Field Programmable Gate Array (FPGA), as only examples, which execute (e.g., processes like a processor) program instructions.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. An apparatus for controlling a cache, comprising:
a cache controller configured to collect a portion of data corresponding to a cache miss in data; and
a data operation unit configured to perform, by way of one or more processors, an operation on the data based on the collected data.

2. The apparatus of claim 1, wherein the cache controller comprises:
a cache hit/miss determining unit configured to determine a cache hit or the cache miss with respect to the data; and
a cache miss data requesting unit configured to request a portion of the data corresponding to the cache miss from an external memory, based on the determined cache hit or cache miss.

3. The apparatus of claim 1, wherein the data comprises video data.

4. The apparatus of claim 3, wherein the data operation unit performs a motion compensation operation on the data based on the collected data.

5. An apparatus for controlling a cache, comprising:
a cache hit/cache miss determining unit configured to verify data sets of a cache miss in data;
a cache miss data requesting unit configured to request the verified data sets from an external memory in an order required for an operation, and to consecutively receive the requested data sets after an overhead of a predetermined time; and
a data operation unit configured to perform, by way of one or more processors, an operation on the data using the data sets that are consecutively received from the external memory after the overhead of the predetermined time.

6. The apparatus of claim 5, wherein
the data sets comprise a first data set and a second data set,
the first data set is a set of data that is required for the operation and is in a cache miss state in data included in a first buffer, and
the second data set is a set of data that is required for the operation and is in the cache miss state in data included in a second buffer.

7. The apparatus of claim 6, wherein the cache miss data requesting unit requests the first data set and the second data set from the external memory, and receives the second data set in succession to the first data set after the overhead of the predetermined time.

8. The apparatus of claim 6, wherein at least one of the first buffer and the second buffer comprises at least one of a line cache and a block cache.

9. The apparatus of claim 6, wherein the cache miss data requesting unit starts to receive the second data set while performing an operation on the first data set.

10. A method of controlling a cache, comprising:
collecting, by a cache controller, a portion of data corresponding to a cache miss in an data; and
performing, by a data operation unit by way of one or more processors, an operation on the data based on the collected data.

11. The method of claim 10, wherein the collecting comprises:
determining, by a cache hit/miss determining unit, a cache hit or the cache miss with respect to the data; and
requesting, by a cache miss data requesting unit, a portion of the data corresponding to the cache miss from an external memory, based on the determined cache hit or cache miss.

12. The method of claim 11, wherein
the data comprises video data, and
the performing comprises performing a motion compensation operation on the data based on the collected data of the portion corresponding to the cache miss.
